(19) United States
(12) Patent Application Publication
(10) Pub. No.: US 2008/0037268 A1
(43) Pub. Date: Feb. 14, 2008

(54) Infrared light irradiating lamp for vehicle

(75) Inventors: Hiroki Tendo, Shizuoka (JP); Shinji Kagiyama, Shizuoka (JP)

Correspondence Address: OSHA LIANG L.L.P., 1221 MCKINNEY STREET, SUITE 2800, HOUSTON, TX, 77010, US

(73) Assignee: KOITO MANUFACTURING CO., LTD., Tokyo (JP)

(21) Appl. No.: 11/890,563

(22) Filed: Aug. 7, 2007

(30) Foreign Application Priority Data
Aug. 9, 2006 (JP) 2006-217481

(51) Int. Cl. F21S 8/10; F21V 7/00

(52) U.S. Cl. 362/510; 362/516

(57) ABSTRACT

An infrared light irradiating lamp for a vehicle includes a projection lens disposed on an optical axis extending in a longitudinal direction of the vehicle; a light source bulb disposed behind the projection lens, the light source bulb including a filament for emitting light; a reflector for reflecting light emitted from the light source bulb in a forward direction; and an infrared light transmitting film provided between the reflector and the projection lens. The light source bulb is disposed such that a longitudinal direction of the filament is substantially orthogonal to the optical axis.

This application claims foreign priority from Japanese Patent Application No. 2006-217481 filed on Aug. 9, 2006, the entire contents of which are hereby incorporated by reference.

### BACKGROUND OF INVENTION

1. Field of the Invention

The present invention relates to an infrared light irradiating lamp for a vehicle, which can irradiate a light of a light source bulb having a filament as an infrared light using a reflector, an infrared light transmitting film, and a projection lens.

2. Background Art

There is an infrared light irradiating lamp for a vehicle, which is loaded onto a car and illuminates a forward part of the vehicle with an infrared light, that can process a photographed image to confirm an obstacle together with a CCD camera having a near-infrared sensitivity or less (for example, see Patent Document 1).

As shown in FIG. 8, an infrared light irradiating lamp 1 for a vehicle of this type has such a structure that a light source bulb 9 to be a visible light source and a reflector 11 taking an almost elliptical spherical shape are disposed in a lighting chamber 7 formed by a lamp body 3 and a front lens 5, and an infrared light transmitting filter 13 in which an infrared light transmitting film for reflecting a visible light component and transmitting an infrared light component is formed in a whole surface region of a glass plate is provided between the light source bulb 9 and the front lens 5 in order to close a whole front opening portion of the lighting chamber 7.

In general, the light source bulb 9 is attached in a so-called rear inserting structure in which it is inserted from a rear part of the reflector 11 along an optical axis Ax of a lamp emitting light and is constituted in such a manner that a whole light emitted from a light source toward the front lens 5 passes through the infrared light transmitting film. A visible light component of the light of the light source, which is reflected by the reflector 11, is cut when the light is transmitted through the infrared light transmitting film. Thus, the light is mainly changed into a light having only an invisible infrared light component and is emitted and distributed forward from the front lens 5.

An infrared light irradiating region in the forward part of the vehicle is photographed by means of a CCD camera having a near-infrared sensitivity or less, which is provided in the front part of the car and is processed by an image processing device. Then, an image is displayed on a monitor screen in a vehicle compartment. A driver can confirm a person, a lane mark, and an obstacle in a distant place using the monitor screen for displaying a field of view in the forward part of the vehicle.
[Patent Document 1] JP-A-2004-87281 Publication

### SUMMARY OF THE INVENTION

In a conventional infrared light irradiating lamp 1 for a vehicle, the light source bulb 9 is attached in the rear inserting structure as described above. As shown in FIG. 9, therefore, long light irregularities 15a, 15b, 15c and 15d in a longitudinal direction of a road surface are radially generated as light irregularities of a filament image of the light source bulb in some cases. The light irregularities 15a, 15b, 15c and 15d are apt to be erroneously recognized as a white line 17 on the road surface. In a detection of the white line through an infrared CCD camera, particularly, there is a problem in that the light irregularities 15a, 15b, 15c and 15d are easily detected erroneously as the white line 17.

With the structure in which the light source bulb is inserted from a rear part, a protrusion from a rear part of a lamp unit is increased and, thus, an overall length of the lamp unit is increased. With the structure in which the light source bulb is inserted from a rear part, a wide hot zone is hard to form in a transverse direction and an advantageous infrared light irradiation to the detection of the white line cannot be carried out.

Accordingly, embodiments of the invention provide an infrared light irradiating lamp for a vehicle in which a light irregularity of a filament image of a light source bulb can be prevented from being generated as a long light irregularity in a longitudinal direction of a road surface, thereby reducing an erroneous detection of a white line due to the light irregularity.

Embodiments of the invention can be achieved by an infrared light irradiating lamp for a vehicle comprising: a projection lens disposed on an optical axis extending in a longitudinal direction of the vehicle; a light source bulb disposed behind of the projection lens, the light source bulb comprising a filament for emitting light; a reflector for reflecting light emitted from the light source bulb in a forward direction; and an infrared light transmitting film provided between the reflector and the projection lens, wherein the light source bulb is disposed such that a longitudinal direction of the filament is substantially orthogonal to the optical axis.

In an infrared light irradiating lamp for a vehicle in accordance with one or more embodiments of the present invention, a light irregularity of a filament image of the light source bulb is generated to be extended in such a direction as to cross a white line on a road surface, and a long light irregularity in a longitudinal direction of the road surface can be prevented from being generated radially as in the conventional lamp for inserting a light source bulb from a rear part. By transversely inserting the light source bulb, moreover, a protrusion from a rear part of a lamp unit is more reduced as compared with the case of the rear insertion. By transversely inserting the light source bulb, moreover, it is possible to form a wide hot zone in a transverse direction.

In an infrared light irradiating lamp for a vehicle in accordance with one or more embodiments of the present invention, the light source bulb is inserted and fixed into the reflector from a side of the optical axis in a position placed apart from the optical axis in a vertical direction.

In an infrared light irradiating lamp for a vehicle in accordance with one or more embodiments of the present invention, when the light source bulb is inserted apart into a lower side of the optical axis, for example, it is possible to maintain a larger reflecting plane which is linked to an upper side of the optical axis from the lower side of the optical axis as compared with the case in which the optical source bulb is disposed on the optical axis and the reflector reflecting plane on a back part is vertically divided into two parts for use. In the case in which the light source bulb is disposed on the optical axis so that the reflector reflecting plane is divided into two parts for use, consequently, it is possible to prevent the waste of the light reflected by the reflecting plane on the lower side when a shade (a shielding member) for forming a cutoff line of a light distribution pattern is present on the lower side of the optical axis, for example. Thus, it is possible to enhance a light utilization efficiency.

In an infrared light irradiating lamp for vehicle in accordance with one or more embodiments of the present invention, the reflector has a reflector reflecting plane which takes an almost elliptical spherical shape and serves to reflect the light emitted from the light source bulb close to the optical axis, the filament should be disposed in the vicinity of a first focal point of the reflector reflecting plane, and the infrared light transmitting film should be disposed in the vicinity of a second focal point of the reflector reflecting plane.

In an infrared light irradiating lamp for a vehicle in accordance with one or more embodiments of the present invention, the infrared light transmitting film is singly disposed between the projection lens and the reflector. Consequently, it is possible to obtain a structure in which the infrared light transmitting film can easily be exchanged. By disposing the infrared light transmitting film in the vicinity of the second focal point to be the proximity of a reflecting light collecting portion, moreover, it is possible to reduce a size of the infrared light transmitting film.

In an infrared light irradiating lamp for a vehicle in accordance with one or more embodiments of the present invention, the infrared light transmitting film is disposed on a back face of the projection lens.

In an infrared light irradiating lamp for a vehicle in accordance with one or more embodiments of the present invention, the infrared light transmitting film can be stuck and disposed on the back face of the projection lens, and it is not necessary to employ a filter structure in the case in which the infrared light transmitting film is disposed as a single member. Consequently, the number of components can be reduced and the structure of the lamp can be simplified. As compared with the case in which the infrared light transmitting film is disposed in the vicinity of the focal point, moreover, it is possible to transmit a light having a comparatively low light density. Therefore, it is possible to lessen a thermal effect of the infrared light transmitting film.

In an infrared light irradiating lamp for a vehicle in accordance with one or more embodiments of the present invention, a light irregularity of a filament image of the light source bulb is generated to be extended in such a direction as to cross a white line on a road surface, and a long light irregularity in a longitudinal direction of the road surface can be prevented from being generated radially as in the conventional lamp for inserting a light source bulb from a rear part. In a detection of a white line through an infrared CCD camera, therefore, it is possible to considerably reduce the erroneous detection of the light irregularity as the white line.

By transversely inserting the light source bulb, a protrusion from a rear part of a lamp unit is reduced more greatly than that in the case of a rear insertion. Consequently, it is possible to reduce an overall length of the lamp unit.

By transversely inserting the light source bulb, it is possible to form a wide hot zone in a transverse direction. By the detection of the white line, it is possible to carry out an advantageous infrared light irradiation.

Other aspects and advantages of the invention will be apparent from the following description and the appended claims.

### BRIEF DESCRIPTION OF THE DRAWINGS

FIG. 1 is a longitudinal sectional view showing an infrared light irradiating lamp for a vehicle according to a first embodiment of the invention,

FIG. 2 is a horizontal sectional view showing a light source unit illustrated in FIG. 1,

FIG. 3 is an explanatory view illustrating a light irregularity which is generated by the infrared light irradiating lamp for a vehicle shown in FIG. 1,

FIG. 4 is a vertical sectional view showing a projection lens in which an infrared light transmitting film is provided on a back face,

FIG. 5 is a longitudinal sectional view showing an infrared light irradiating lamp for a vehicle according to a second embodiment of the invention,

FIG. 6 is an exploded perspective view showing a light source unit illustrated in FIG. 5,

FIG. 7 is an enlarged perspective view showing an infrared light transmitting filter 85 illustrated in FIG. 6,

FIG. 8 is a longitudinal sectional view showing a conventional infrared light irradiating lamp for a vehicle, and

FIG. 9 is an explanatory view illustrating a light irregularity generated by the conventional infrared light irradiating lamp for a vehicle.

### DETAILED DESCRIPTION OF THE EXEMPLARY EMBODIMENTS

Embodiments of an infrared light irradiating lamp for a vehicle according to the invention will be described below in detail with reference to the accompanying drawings. Like items in the figures are shown with the same reference numbers. In this application, a longitudinal direction of the vehicle is the direction in which a vehicle incorporating the infrared light irradiating lamp would travel, and front and forward denote a forward direction of travel of the vehicle, while behind and rear denote a backward direction of travel of the vehicle. A vertical direction is a direction perpendicular to a ground plane of the vehicle. A longitudinal direction of a filament is a direction in which the filament has the greatest length.

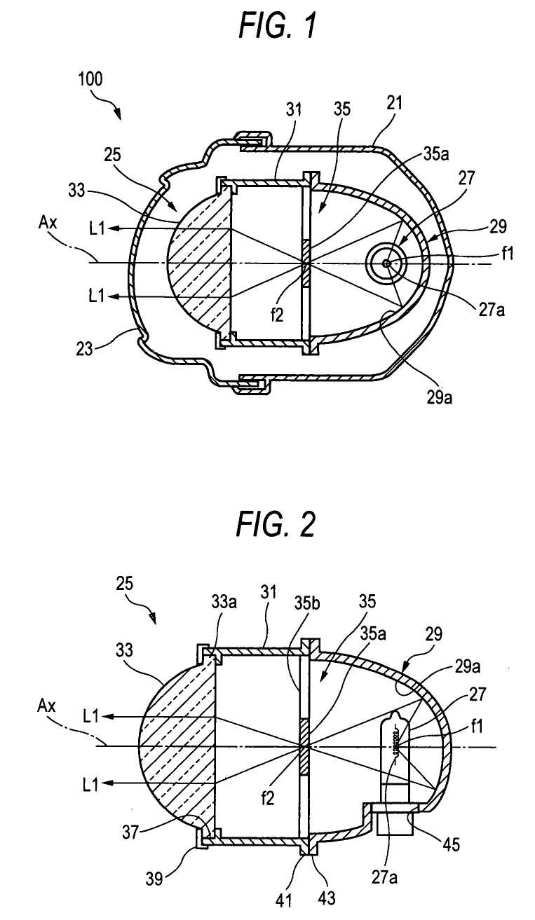

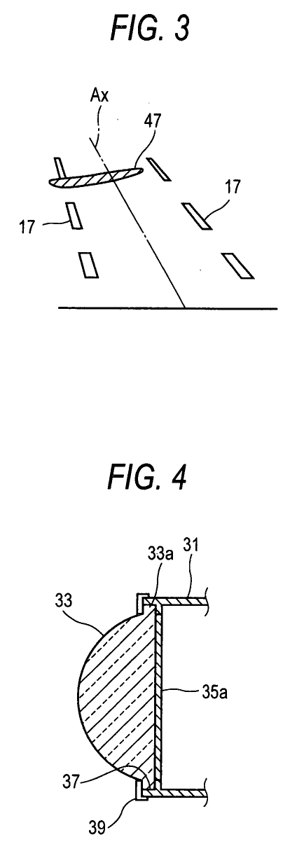

FIG. 1 is a longitudinal sectional view showing an infrared light irradiating lamp for a vehicle according to a first embodiment of the invention, FIG. 2 is a horizontal sectional view showing a light source unit illustrated in FIG. 1, FIG. 3 is an explanatory view illustrating a light irregularity generated by the infrared light irradiating lamp for a vehicle illustrated in FIG. 1, and FIG. 4 is a vertical sectional view showing a projection lens in which an infrared light transmitting film is provided on a back face.

An infrared light irradiating lamp 100 for a vehicle according to the first embodiment is used in a night forward visual field detecting system and is provided in a front portion of a vehicle to irradiate an infrared light onto a forward part of the vehicle, for example. The night forward visual field detecting system is constituted by the infrared light irradiating lamp 100 for a vehicle shown in FIG. 1, an infrared light compatible CCD camera (not shown) which is provided in an upper part in a vehicle compartment and serves to photograph a view of field in the forward part of the vehicle, for example, an image processing analyzing apparatus (not shown) for analyzing an image photographed by the CCD camera, and a head up display (HUD) (not shown) for displaying data analyzed by the image processing analyzing apparatus.

Images of invisible distant pedestrians, obstacles, or lane marks which are photographed by the CCD camera are sent to the image processing analyzing apparatus. By carrying out an edge processing or a pattern recognition from the images, it is possible to easily recognize the pedestrians, the obstacles, and the lane marks.

The images of the pedestrians, the obstacles, and the lane marks can be given to a driver through the head up display (HUD), and can decide the features of the objects on a road (the pedestrians, the obstacles, and the lane marks) through a shape recognition, thereby giving a notice to the driver in a voice.

The infrared light irradiating lamp 100 for a vehicle is constituted by a lamp body 21 formed of a synthetic resin which has a front side opened and takes a shape of a vessel, a transparent front cover 23 assembled into the front opening portion of the lamp body 21 and serving to partition and form a lighting chamber S in cooperation with the lamp body 21, and a projection type light source unit 25 accommodated in the lighting chamber S and supported to be regulated tiltably in vertical and transverse directions by means of an aiming mechanism which is not shown.

As shown in FIG. 2, the projection type light source unit 25 has a light source bulb 27 having a filament 27a for emitting a light, a reflector 29 formed by aluminum die casting into which the light source bulb 27 is inserted and attached, and a convex lens (a projection lens) 33 integrated with a forward part of the reflector 29 through a cylindrical lens holder 31 and disposed on an optical axis Ax extended in a longitudinal direction of the vehicle. The reflector 29 has a reflector reflecting plane 29a taking an almost elliptical spherical shape and serving to reflect a light emitted from the light source bulb 27 close to the optical axis Ax.

The projection type light source unit 25 has such a structure that the filament 27a of the light source bulb 27 is positioned on a first focal point f1 of the reflecting plane 29a in the reflector 29 and a second focal point f2 of the reflecting plane 29a is positioned in the vicinity of a rear focal point of the convex lens 33 so that a light of the light source which is reflected by the reflecting plane 29a to be an effective reflecting plane subjected to an aluminum evaporation treatment in the reflector 29 is changed into an almost parallel light L1 through the convex lens 33 and is thus projected and distributed. More specifically, a light distribution pattern created by the projection type light source unit 25 is the same as that of a headlamp of a car for forming a main beam.

Furthermore, an infrared light transmitting filter 35 is provided between the reflector 29 and the convex lens 33, that is, on a rear end side of the lens holder 31.

In the infrared light transmitting film 35, an infrared light transmitting film 35a for reflecting a visible light component and transmitting an infrared light component is formed circularly on a back face of a glass plate 35b. The infrared light transmitting film 35a is disposed in the vicinity of the focal point f2 of the reflector reflecting plane 29a in the reflector 29.

The projection type light source unit 25 according to the embodiment has such a structure that the infrared light transmitting filter 35 is singly disposed between the convex lens 33 and the reflector 29 so that the infrared light transmitting filter 35 can easily be exchanged. By disposing the infrared light transmitting film 35a in the vicinity of the second focal point f2 in the proximity of a light collecting portion, moreover, it is possible to reduce a size (a diameter) of the infrared light transmitting film 35a.

The lens holder 31 is formed by the same aluminum die casting as the reflector 29, and a front edge portion thereof is circumferentially provided with a lens engaging portion 37 taking a shape of an inner flange with which a peripheral flange portion 33a of the convex lens 33 can be engaged.

A lens holding frame 39 formed of a metal and taking a shape of a circular ring is fixed to the front edge portion of the lens holder 31, and the peripheral flange portion 33a of the convex lens 33 is fixed and held in an engaging state with the lens engaging portion 37. In the lens holder 31 and the reflector 29, coupling flange portions 41 and 43 are bonded to each other by bonding means which is not shown, for example, a screw.

The light source bulb 27 of the projection type light source unit 25 is attached to an attaching opening portion 45 provided on a side of the reflector 29 and is inserted and fixed into the reflector 29 from the side of the optical axis Ax as shown in FIG. 2. More specifically, while the light source bulb 9 in the conventional infrared light irradiating lamp 1 for a vehicle shown in FIG. 8 has a rear inserting structure, the light source bulb 27 in the infrared light irradiating lamp 100 for a vehicle according to the embodiment has a transverse inserting structure. Consequently, the projection type light source unit 25 is disposed in such a manner that a longitudinal direction of the filament 27a is almost orthogonal to the direction of the optical axis Ax.

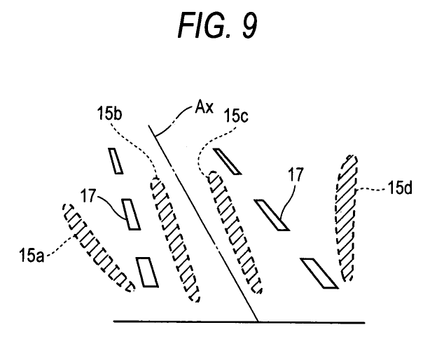

According to the infrared light irradiating lamp 100 for a vehicle in accordance with one or more embodiments, a light irregularity 47 of a filament image of the light source bulb 27 is generated to be extended in such a direction as to cross the white line 17 on the road surface as shown in FIG. 3. Therefore, long light irregularities 15a, 15b, 15c and 15d (see FIG. 9) in a longitudinal direction of the road surface are prevented from being generated radially as in the conventional infrared light irradiating lamp 1 for a vehicle in which the light source bulb 27 is inserted from a rear part.

In the detection of the white line through an infrared CCD camera in an image processing analyzing apparatus, consequently, the light irregularity 47 is hard to erroneously detect as the white line 17. Thus, it is possible to considerably enhance precision in the detection of the white line.

By transversely inserting the light source bulb 27, moreover, the protrusion from the rear portion of the lamp body 21 is reduced more greatly than that in the conventional rear inserting structure. Consequently, it is possible to reduce the overall length of the lamp unit.

By transversely inserting the light source bulb 27, furthermore, the filament 27a of the light source bulb 27 is extended in a transverse direction. Consequently, it is possible to form a wide hot zone in which an irradiated light is enlarged in the transverse direction. By the detection of the white line, it is possible to carry out an advantageous infrared light irradiation.

While the infrared light transmitting filter 35 having the infrared light transmitting film 35a is independently disposed between the convex lens 33 and the reflector 29 in the embodiment, the infrared light transmitting film 35a may be disposed on the back face of the convex lens 33 as shown in FIG. 4.

With the structure, by disposing the infrared light transmitting film 35a on the back face of the convex lens 33, it is not necessary to employ a filter structure in the case in which the infrared light transmitting filter 35 is disposed as a single member. Consequently, the number of components can be decreased and a lamp structure can be simplified. As compared with the case in which the infrared light transmitting filter 35 is disposed in the vicinity of the focal length, it is possible to transmit a light having a comparatively low light density. Thus, it is possible to lessen a thermal influence for the infrared light transmitting film 35a.

While the first focal point f1 and the second focal point f2 are placed in positions apart from each other in the reflector reflecting plane 29a taking an almost elliptical spherical shape in the embodiment, moreover, this is not restricted but the first focal point and the second focal point may be almost coincident with each other, that is, a spherical reflector reflecting plane may be employed.

Next, description will be given to an infrared light irradiating lamp for a vehicle according to a second embodiment of the invention.

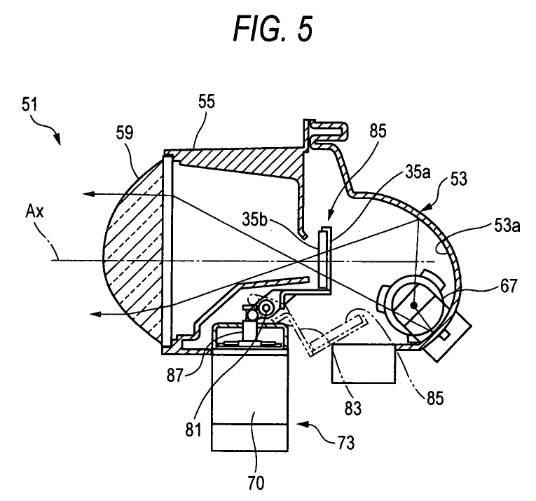

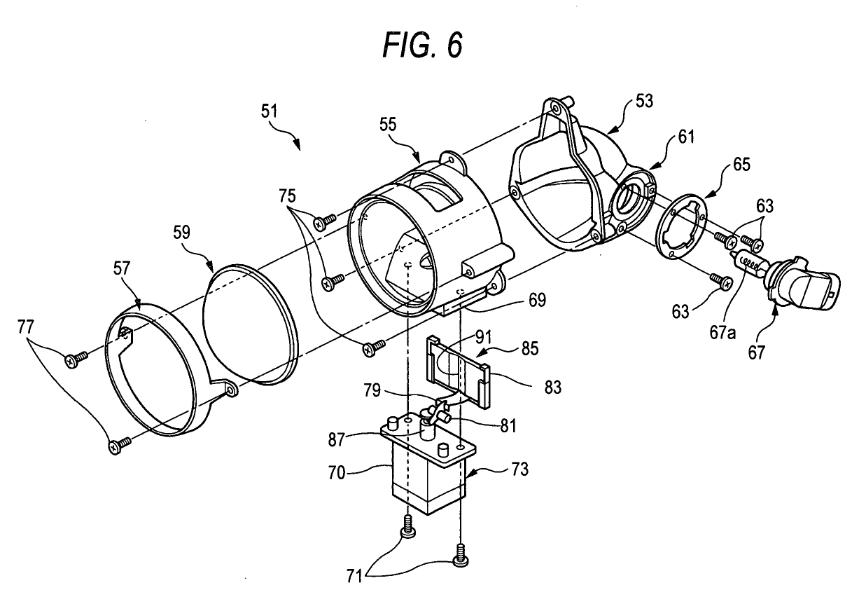

FIG. 5 is a longitudinal sectional view showing a light source unit of an infrared light irradiating lamp for a vehicle according to the second embodiment of the invention, and FIG. 6 is an exploded perspective view showing the light source unit illustrated in FIG. 5. The same components as those in the infrared light irradiating lamp for a vehicle according to the first embodiment have the same reference numerals and detailed description will be omitted.

In the same manner as the infrared light irradiating lamp 100 for a vehicle according to the first embodiment, the infrared light irradiating lamp for a vehicle according to the second embodiment is constituted by a lamp body 21 formed of a synthetic resin, a transparent front cover 23 for partitioning a lighting chamber S in cooperation with the lamp body 21, and a projection type light source unit 51 supported to be regulated tiltably in vertical and transverse directions by an aiming mechanism, which is not shown.

As shown in FIGS. 5 and 6, the projection type light source unit 51 according to the second embodiment has a reflector 53 formed by aluminum die casting, a cylindrical lens holder 55, a convex lens (a projection lens) 59 integrated with a forward part of the reflector 53 through a lens fitting 57 and disposed on an optical axis Ax extended in a longitudinal direction of the vehicle, a socket fixture 65 fixed, with a screw 63, to an attaching opening portion 61 formed in a side portion of the reflector 53, a light source bulb 67 attached to the socket fixture 65, and a filter driving unit 73 fixed, with a screw 71, to an attaching opening portion 69 opened in a lower part of the lens holder 55. The lens holder 55 is fixed to the reflector 53 with a screw 75, and the lens fitting 57 is fixed to the lens holder 55 with a screw 77.

The filter driving unit 73 has such a structure that a filter bracket (a movable member) 83 can displace an infrared light transmitting filter 85 held in the filter bracket 83 between a position in which a light reflected by the reflector 53 is intercepted and a position in which the reflected light is not intercepted by means of an electric type reciprocating actuator 70.

More specifically, the infrared light transmitting filter 85 is supported on one of rotating ends of a support portion 79, which is rotatable around a horizontal shaft 81, and a plunger 87 of the reciprocating actuator 70 is linked to the other rotating end. When the plunger 87 carries out a vertical operation, the filter bracket 83 is rocked.

When the filter bracket 83 is disposed in the position in which the light reflected by the reflector 53 is intercepted, the light emitted from the light source bulb 67 is transmitted through the infrared light transmitting filter 85 so that the light can be used as an infrared light irradiating lamp. On the other hand, when the filter bracket 83 is disposed in the position in which the light reflected by the reflector 53 is not intercepted, the light emitted from the light source bulb 67 is irradiated as a direct visible light and can be used as a normal headlight.

In other words, according to the infrared light irradiating lamp in accordance with the embodiment, one lamp can be caused to function as two different lamp units, that is, an infrared light irradiating lamp and a normal illuminating lamp.

In the projection type light source unit 51 related to the infrared light irradiating lamp for a vehicle in accordance with the second embodiment, as shown in FIG. 5, the light source bulb 67 is inserted and fixed into the reflector 53 from the side of the optical axis Ax in a position placed apart in a vertical direction from the optical axis Ax (a position placed apart in a downward direction in the embodiment).

More specifically, with the conventional structure in which the light source bulb 9 is disposed on the optical axis as shown in FIG. 8, in the case in which the reflector reflecting plane is vertically divided into two parts and a shielding member such as a shade is provided on a lower side, a light reflected by the reflecting plane on a lower side is cut and is thus wasted. Accordingly, only the reflecting plane on an upper side, which is divided into two parts and has a small area, is effective. Thus, a light utilization efficiency is reduced.

On the other hand, when the light source bulb 67 is inserted apart into the lower side of the optical axis Ax as in one or more embodiments of the present invention, it is possible to maintain a larger reflector reflecting plane 53a, which is continuous from the lower side of the optical axis Ax to the upper side thereof, as compared with the case in which the reflector reflecting plane is vertically divided into two parts for use. Consequently, it is possible to minimize a waste of the light reflected by the reflecting plane on the lower side when the shielding member such as the shade or the filter driving unit 73 is present on the lower side of the optical axis Ax, for example. Thus, it is possible to enhance the light utilization efficiency.

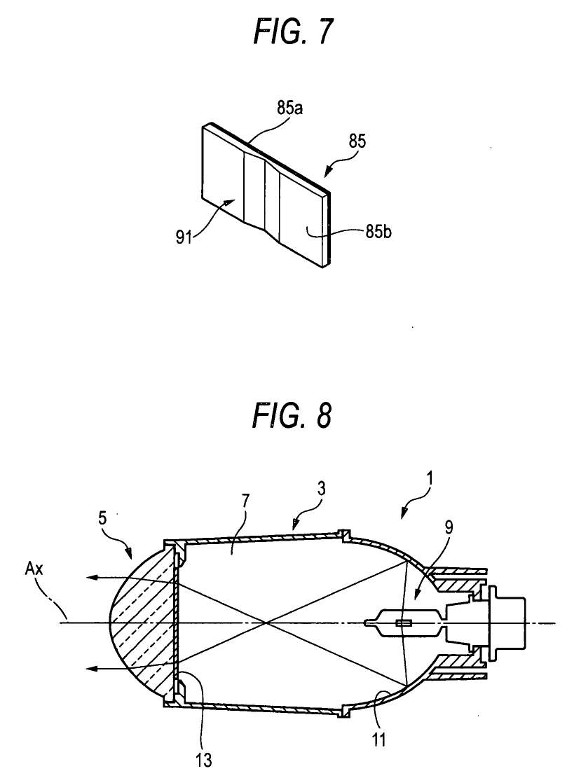

FIG. 7 is an enlarged perspective view showing the infrared light transmitting filter 85 illustrated in FIG. 6.

The infrared light transmitting filter 85 is obtained by depositing, on a glass plate 85b, an infrared light transmitting film 85a for reflecting a visible light component and transmitting an infrared light component as shown in FIG. 6.

Moreover, a diffusing portion 91 is formed to have a V-groove-shaped section which is extended vertically on a surface at an opposite side of the reflector 53, that is, a surface of the glass plate 85b which is opposed to a back face of the convex lens 59. The diffusing portion 91 is formed adjacently to the infrared light transmitting film 85a.

According to the infrared light transmitting filter 85 having the diffusing portion 91, it is possible to diffuse an infrared light in a transverse direction by the diffusing portion 91 and to complement a light to be irradiated in a side direction of a vehicle, that is, a pavement or a shoulder of a road.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### <Description of the Reference Numerals and Signs>

27 . . . light source bulb
27a . . . filament
29 . . . reflector
29a . . . reflector reflecting plane
33 . . . convex lens (projection lens)
35a . . . infrared light transmitting film
100 . . . infrared light irradiating lamp for vehicle
Ax . . . optical axis
f1 . . . first focal point
f2 . . . second focal point

What is claimed is:

1. An infrared light irradiating lamp for a vehicle comprising:
a projection lens disposed on an optical axis extending in a longitudinal direction of the vehicle;
a light source bulb provided behind the projection lens, the light source bulb comprising a filament for emitting light;
a reflector for reflecting light emitted from the light source bulb in a forward direction; and
an infrared light transmitting film disposed between the reflector and the projection lens,
wherein the light source bulb is disposed such that a longitudinal direction of the filament is substantially orthogonal to the optical axis.

2. The infrared light irradiating lamp for a vehicle according to claim 1, wherein the light source bulb is inserted and fixed into the reflector from a side of the optical axis in a position placed apart from the optical axis in a vertical direction.

3. The infrared light irradiating lamp for a vehicle according to claim 1, wherein the reflector has a reflector reflecting plane which takes a substantially elliptical spherical shape and serves to reflect the light emitted from the light source bulb close to the optical axis,
the filament is disposed in the vicinity of a first focal point of the reflector reflecting plane, and
the infrared light transmitting film is disposed in the vicinity of a second focal point of the reflector reflecting plane.

4. The infrared light irradiating lamp for a vehicle according to claim 1, wherein the infrared light transmitting film is disposed on a back face of the projection lens.

5. The infrared light irradiating lamp for a vehicle according to claim 2, wherein the reflector has a reflector reflecting plane which takes a substantially elliptical spherical shape and serves to reflect the light emitted from the light source bulb close to the optical axis,
the filament is disposed in the vicinity of a first focal point of the reflector reflecting plane, and
the infrared light transmitting film is disposed in the vicinity of a second focal point of the reflector reflecting plane.

6. The infrared light irradiating lamp for a vehicle according to claim 2, wherein the infrared light transmitting film is disposed on a back face of the projection lens.

7. The infrared light irradiating lamp for a vehicle according to claim 1, further comprising a filter driving unit disposed between the projection lens and the light source bulb, the filter driving unit comprising a movable shaft to be driven in a vertical direction.

8. The infrared light irradiating lamp for a vehicle according to claim 1, further comprising a diffusing portion for diffusing light transmitted from the reflector.

9. The infrared light irradiating lamp for a vehicle according to claim 8, wherein the diffusing portion comprises a V-groove shaped section extending vertically on a surface thereof.

10. The infrared light irradiating lamp for a vehicle according to claim 9, wherein V-groove shaped section is disposed on a surface of the diffusing portion at an opposite side of the reflector.

11. The infrared light irradiating lamp for a vehicle according to claim 8, the diffusing portion is disposed adjacently to the infrared light transmitting film.

12. The infrared light irradiating lamp for a vehicle according to claim 1, further comprising a infrared light transmitting filter mount on a bracket, wherein the infrared light transmitting filter comprises the infrared light transmitting film.
